(19) United States
(12) Patent Application Publication
(10) Pub. No.: US 2013/0333817 A1
(43) Pub. Date: Dec. 19, 2013

(54) RUBBER COMPOSITION FOR TIRE VALVE AND TIRE VALVE

(71) Applicant: Donald James Burlett, Oxford, MI (US)

(72) Inventor: Donald James Burlett, Oxford, MI (US)

(73) Assignee: THE GATES CORPORATION, Denver, CO (US)

(21) Appl. No.: 13/525,537

(22) Filed: Jun. 18, 2012

(51) Int. Cl. B60C 29/02; B29C 70/68

(52) U.S. Cl. 152/427; 264/135

(57) ABSTRACT

A tire valve for snap-in mounting in a valve hole in a wheel rim, having a resilient member surrounding and bonded to at least a portion of the valve body, wherein the resilient member is a vulcanized rubber composition comprising ethylene alpha-olefin elastomer, carbon black, high-density inert filler, and an efficient vulcanization cure system.

### BACKGROUND OF THE INVENTION

1. Field of the Invention

This invention relates generally to a tire valve, more particularly to a rubber composition for a snap-in tire valve, and specifically to a snap-in tire valve with an EV-cured, EPDM, rubber composition.

2. Description of the Prior Art

Tire valves of the snap-in type are known. A shaped resilient rubber sealing member is commonly over-molded around a brass valve body. The seal shape generally includes a circumferential ridge or rib that must be compressed or otherwise deformed to let the seal snap into the valve hole in the wheel rim and a groove that retains the valve in the valve hole. The resilient seal then supports the valve body and seals the hole. The support and sealing functions are expected to last the life of the tire. U.S. Pat. Nos. 3,287,485 and 3,670,688 disclose examples of valves of rubber and brass that snap into a wheel rim. The '485 patent discloses a styrene-butadiene rubber (SBR) formulation with 2.5 phr sulfur and 0.75 phr accelerator, and a butyl rubber (BR) formulation with 4 phr sulfur and 2 phr accelerator, useful for a rubber seal. The '688 patent discloses that various primers and other adhesive compositions may be applied to bond the rubber member to the valve body. Sulfur-cured ethylene propylene diene elastomer (“EPDM”) and natural rubber have also been used for the rubber component.

Tire pressure monitoring system (“TPMS”) applications generally include a pressure sensing module mounted on the valve body inside the wheel. U.S. Pat. Nos. 6,005,480 and 7,281,421 disclose tire pressure sensor assemblies including a tire valve that can snap into a wheel rim. The added mass of the sensor results in much higher demands placed on the rubber sealing member of the valve. These demands are further aggravated by high speeds of revolution, high accelerations, and by wheels that are reportedly running hotter than in the past which may be due to heat transferred to wheel rims from brake systems. Thus, applications of TPMS can experience accelerations of up to 1400 Gs and operating temperatures of up to 100° C. These demands have caused conventional snap-in tire valves to fail early due to cracks at various critical locations in the rubber seal, adhesion loss, and/or other problems due to thermal or heat aging of the rubber.

Snap-in tire valves are to be distinguished from other designs, such as bolt-on designs, rigid designs, and the like, which use entirely different sealing methods, such as o-rings, gaskets, permanent welds, or the like.

### SUMMARY

The present invention is directed to systems and methods which provide snap-in tire valves with improved high speed and high temperature performance, especially suitable for use in modern tire pressure monitoring systems and applications.

The invention is directed to a snap-in tire valve for mounting in a valve hole in a wheel rim, having a valve body and a resilient member having an overall shape including a groove and a rib adapted to snap into and be retained in the hole. According to one embodiment of the invention, the resilient member includes a vulcanized rubber composition of ethylene alpha-olefin elastomer, carbon black, a high-density inert filler, and an efficient vulcanization (“EV”) cure system.

The elastomer may be ethylene propylene diene elastomer (“EPDM”). The EPDM may have ENB as the diene and the amount of said diene in the EPDM may be in the range 3-5 mole %. The EPDM may have ethylene content in the range of 60-70 mole %. The EPDM may be an oil-extended, high molecular weight grade of EPDM comprising at least 50 parts by weight of oil per hundred parts EPDM. The vulcanized rubber composition may include at least 75 parts by weight of oil per hundred parts EPDM.

The EV cure system comprises elemental sulfur and cure accelerators, which may be present in a ratio of cure accelerators to elemental sulfur in the range from about 4:1 or more up to about 10:1, preferably greater than 6:1. The EV cure system may include less than 1 part of elemental sulfur by weight per hundred parts elastomer, preferably less than 0.8 phr sulfur.

The vulcanized rubber composition may have a tensile stress at 10% elongation in the range of greater than 90 psi, preferably greater than 100 psi; and a tensile stress at 100% elongation in the range of less than 550 psi, preferably less than 500 psi.

The tire valve may have an adhesive layer between the valve body and the resilient member.

The high-density inert filler may be barium sulfate and may be present in the range of 10 to 30 parts weight per hundred parts of elastomer. The barium sulfate may have an average particle size less than 20 μm. The resulting density of the rubber composition or compound may advatageously be 1.1 g/cc or greater, preferably 1.10-1.20 g/cc.

The invention is also directed to a method comprising:

i) applying an adhesive to a brass tire valve stem;

ii) over-molding the adhesive coated brass tire valve stem with a rubber composition comprising ethylene propylene elastomer, carbon black, high-density inert filler, and an EV cure system; and

iii) vulcanizing the over-molded stem with rubber composition to produce a rubber seal shaped to snap into a valve hole in a wheel rim.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a perspective view of an embodiment of the invention; and

FIG. 2 is a partially fragmented, half-sectional view of another embodiment of the invention.

### DETAILED DESCRIPTION

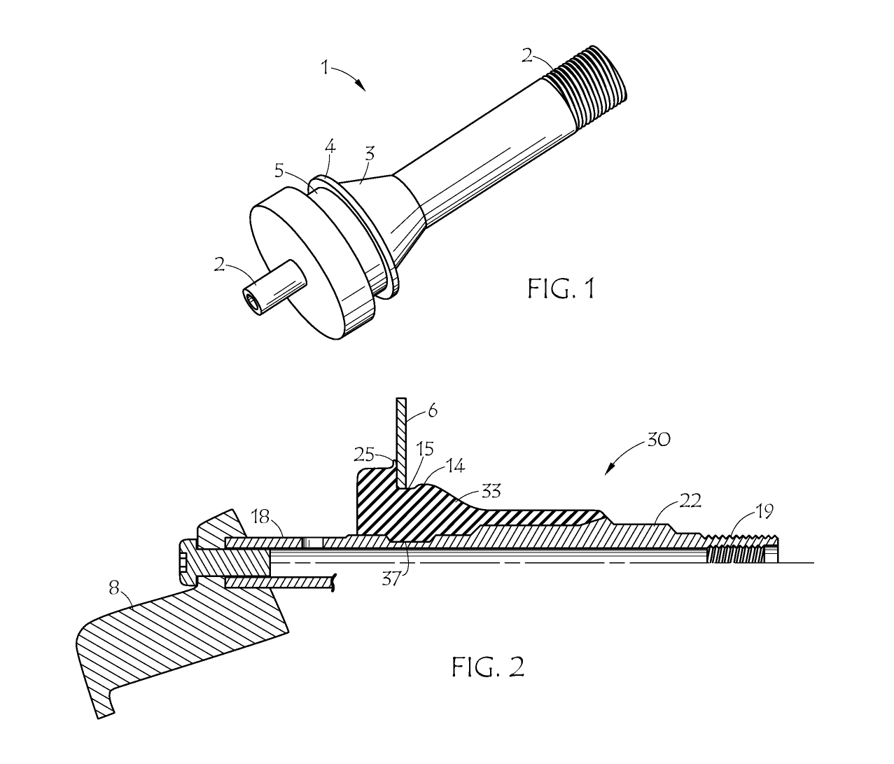

FIG. 1 shows an embodiment of a snap-in tire valve. Tire valve 1 includes brass valve body 2 arranged along the axis thereof and resilient member 3 over-molded around the outside surface of the brass valve body. The resilient member is shaped so that it can be inserted into a valve opening or hole in a wheel rim (not shown). Rib 4 is larger than the valve hole diameter, so that the rib must deflect as the tire valve is pulled though the hole. Groove 5 has an outside diameter somewhat bigger than the hole so that when the edge of the hole snaps into the groove, the resilient member residing between the edge of the hole and the brass valve body, i.e., the resilient member in the vicinity of the groove, remains in compression to effect an air-tight seal between the valve body and the wheel rim. In other words, groove 5 provides the sealing surface of the tire valve. The resilient member conventionally consisted of a conventional sulfur-cured, rubber composition. According to the invention, the resilient member 3 comprises an EV-cured, rubber composition, preferably of EPDM elastomer.

FIG. 2 shows an embodiment of a snap-in tire valve with pressure sensor housing. Tire valve 30 includes brass valve body 22 arranged along the axis thereof and resilient member 33 over-molded around the outside surface of the brass valve body. The resilient member is shaped so that it can be inserted into a valve opening or hole in wheel rim 6. Rib 14 is larger than the valve hole diameter, so that the rib must deflect as the tire valve is pulled through the hole from left to right in FIG. 2. Groove 15 has an outside diameter somewhat bigger than the hole so that when the edge of the hole snaps into the groove, the resilient member residing between the edge of the hole and the brass valve body, i.e., the resilient member in the vicinity of the groove, remains in compression to effect an air-tight seal between the valve body and the wheel rim. The inside portion of groove 15 includes a flange or lip 25 which is shown spread outward against the inside surface of wheel rim 6 upon installation. Resilient member 33 is seated in recess 37 in valve body 22 for extra holding power. The external end 19 of valve body 22 is threaded externally for a cap or threaded hose fitting (not shown), and threaded internally for a conventional valve core or other components (not shown, but well-known). The internal end 18 of valve body 22 may be adapted as desired, for example, for attaching a housing for TPMS components located inside the wheel. Note that “internal” and ‘external” may be used herein to refer to the location of a portion of a valve with respect to the wheel it is to be mounted on, internal being the side the tire is mounted on and thus internal with respect to the tire; external being the other side or outside the tire. Thus, FIG. 2 illustrates TPMS housing 8 mounted on internal end 18 of valve body 22 in the interior of wheel rim 6. Recess 37 and lip 25 are examples of optional useful features which may advantageously be incorporated into various embodiments of the present invention, and other such features are further described in the U.S. Patent Application Publication No. 2012/103432A1, the entire contents of which are hereby incorporated herein by reference. According to the invention, the resilient member 33 comprises an EV-cured, rubber composition.

The invention solves the problems of the prior art by utilizing a new rubber composition for the resilient element. The rubber composition includes a heat-resistant elastomer such as EPDM, with an EV-cure system, and a high-density inert filler.

The heat resistant elastomer may be one of those having a saturated backbone that is sulfur curable such as many of those listed in ASTM D-1418 section 3.1, including ethylene-propylene diene elastomer (EPDM), and the like. Alternately, the heat resistant elastomer may be a highly saturated elastomer (due to hydrogenation or the like) such as hydrogenated nitrile (HNBR), hydrogenated SBR (HSBR) or the like. Preferably the heat resistant elastomer is an ethylene-alpha-olefin elastomer, such as an ethylene-propylene-diene elastomer (i.e., EPDM), ethylene-butene elastomer or ethylene-octene elastomer. The invention does not include the use of minor amounts of EPDM or EPM as an additive to non-heat-resistant elastomers such as SBR, NBR, or NR. Non-heat-resistant elastomers which are excluded generally include those with unsaturated backbone chains such as diene-based rubbers.

Useful EPDM grades include those with diene components such as ethylidene norbornene (ENB), dicyclopentadiene, or 1,4-hexadiene. The diene is preferably ENB. The amount of diene monomer in the EPDM may be from 1 to 8 mole %, and is preferably in the range 3 to 5 mole %. The ethylene content in the EPDM may be from 50 to 80 mole %, and is preferably in the range 60 to 70 mole %. The molecular weight of the EPDM elastomer may be indicated by the Mooney viscosity (“MV”), which may suitably be in the range 50 or more, based on ML1+4 at 125° C. according to ASTM D-1646-04 part A, massed or unmassed. The EPDM may advantageously be an oil-extended grade comprising naphthenic or paraffinic oil added to an EPDM polymerized to a much higher than normal molecular weight and Mooney viscosity. The oil is useful to solubilize the EV cure accelerators and thus prevent accelerator bloom on the surface of the rubber member of the inventive tire valve.

EV stands for “efficient vulcanization” and refers to an accelerated sulfur cure system having a rather high ratio of cure accelerator to sulfur, making the sulfur usage in crosslinking “efficient.” EV-cure systems can therefore result in a relatively high percentage of monosulfidic crosslinks compared to the predominantly polysulfidic crosslinks resulting from conventional sulfur-cure systems. The EV-cure system may include one or more accelerators and elemental sulfur. The accelerators may be one or more selected from very fast (or ultra) accelerators, fast accelerators, medium fast accelerators, primary accelerators, secondary accelerators, or other accelerator classifications in use in the art. The choice of accelerator (or combination of accelerators) will depend on the choice of elastomer and balance of properties desired, including cure delay, cure rate, cure temperature, heat resistance, flex resistance, compression set resistance, and so on. The classification of accelerators is not exact, and many accelerators may be considered to be in more than one classification. Many of the useful accelerators are sulfur donors.

Sulfenamides are useful as fast vulcanization accelerators with delayed curing action. Examples of sulfenamide accelerators include N-cyclohexyl-2-benzothiazyl sulfenamide (CBS), N-t-butyl-2-benzothiazyl sulfenamide (TBBS), N-t-butyl-2-benzothiazol sulphenamide (TBSI), N,N-dicyclohexyl-2-benzothiazyl sulfenamide (DCBS), N,N-diisopropyl-2-benzothiazyl sulfenamide (DIBS), 2-(4-morpholinylthio)-benzothiazyl (MBS), 2-(4-morpholinyldithio)-benzothiazyl (MBDS), benzothiazyl-2-t-amyl sulphenamide (AMZ), morpholin-thiocarbonyl sulphenmorpholine (OTOS), and N-cyclohexyl-bis-benzothiazole sulfenamide (CBBS), and mixtures thereof

Other useful fast accelerators include thiazoles such as 2-mercaptobenzothiazole (MBT), zinc salt of 2-mercaptobenzothiazole (ZMBT), dibenzothiazyl disulphide (MBTS), 2-morpholinodithio-benzothiazole, and mixtures thereof.

The rubber composition may further include one or more accelerator selected from the class of the so-called very fast accelerators or ultra accelerators, among which guanidines, dithiocarbamates, thiurams, and mixtures thereof. Particularly effective very fast accelerators are those selected from the group comprising zinc, bismuth, cadmium, lead, copper, selenium, tellurium and iron dithiocarbamates. Among them, very fast accelerators of preferred use are those selected from the group comprising: zinc dimethyl dithiocarbamate (ZDMC), zinc diethyl dithiocarbamate (ZDEC), zinc dibutyl dithiocarbamate (ZDBC), zinc ethyl-phenyl dithiocarbamate (ZEPC), zinc dibenzyl dithiocarbamate (ZBEC), and mixtures thereof.

Useful guanidine accelerators include diphenyl guanidine (DPG), di-o-tolylguanadine (DOTG), and o-tolylbiguanadine and mixtures thereof.

Thiourea accelerators which are useful in the rubber composition of the invention include thiourea and hydrocarbon-substituted thioureas such as N,N′-dibutylthiourea, trimethylthiourea, N,N′-diethylthiourea, tetramethylthiourea and ethylenethiourea.

Useful thiuram accelerators include N, N′-dimethyl-N,N′-diphenyl thiuram disulfide, dipentamethylene thiuram hexasulfide, tetrabutylthiuram monosulfide, tetraethylthiuram disulfide, tetramethylthiuram disulfide (TMTD), tetramethylthiuram monosulfide (TMTM), and dimethyl morpholino thiuram disulfide.

Although peroxide curatives are commonly used to achieve high heat-resistant rubber compositions, sometimes in conjunction with one or more of the accelerators described above and/or with some sulfur, they are not considered part of the EV cure system of the invention.

The high-density filler is preferably an inert filler such as barium sulfate (also known as barytes) or titanium dioxide or a combination of such fillers. Barium sulfate has a density of 4.39 g/cc. Inert herein means a filler with no significant reinforcing effect and also no significant participation in cure reactions or effect on the cure system. Other more reactive high density fillers may be useful, such as ZnO, ZnS, PbO, MgO, Sb2O3, and the like, but they present the risk of affecting cure rates or physical properties. Other common reinforcing or semi-reinforcing fillers such as carbon black, silica or clays may not be as effective because they are not high enough in density and/or because they exhibit reinforcing effects that degrade processability and/or make final properties unacceptable. It is believed that the inert high-density filler is particularly helpful to reduce the permeability to air of the resilient rubber element without causing excess modulus or viscosity. The density of the filler may be greater than about 3 g/cc, or preferably about 4 g/cc or greater. The high-density inert filler is preferably present at a concentration of at least about 10 parts per hundred parts of elastomer (“PHR”), preferably at least 15 PHR, or about 20 PHR, or up to about 30 PHR. The resulting density of the rubber composition or compound should preferably be 1.1 g/cc or greater, preferably 1.10-1.20 g/cc, i.e., to exhibit an increase in density without overly increasing modulus. A conventional amount of ZnO of about 5 PHR is not considered to meet or contribute to the high-density inert filler of the inventive composition. The use of high-density inert filler is in addition to any conventional amount of ZnO, typically around 5 PHR.

In addition to the sulfur, accelerator and the high-density filler, the rubber composition can contain other compounding ingredients, including carbon black, other fillers, oil, zinc oxide, stearic acid and antidegradants. These materials may be mixed into the rubber by using a mill or an internal mixer such as a Banbury mixer.

The rubber composition may exhibit excellent adhesion to brass and other metals, or a primer and/or adhesive coating may be used to facilitate bonding of the rubber of the resilient member to the brass valve body. Examples of suitable adhesive coating systems include members of the CHEMLOK and CHEMOSIL series sold under those trade marks by Lord Corporation; members of the THIXON, MEGUM and ROBOND series sold under those trademarks by The Dow Chemical Company; and various others such as sold by Master Bond Inc., Weicon GmbH, and the like.

Preferably, the rubber composition exhibits somewhat higher modulus values than prior art compositions, at least at low elongations representative of the stresses encountered when the valve is seated in the wheel rim valve hole. At relatively high elongations representative of the stresses encountered when the valve is being pulled into the hole, high modulus can be detrimental. Modulus may be determined using common tensile modulus measurements, for example in accordance with ASTM D-412, and modulus may be indicated by tensile stress at given elongation as defined in ASTM D-1566 and D-412. Herein, modulus measurements are equated with tensile stress at given elongation and indicated by the letter “S” followed by the given elongation. Thus, “S100” means the tensile stress at 100% elongation and may be referred to as the “100% modulus.” Herein, S100 is believed to correlate with installation force. Likewise, “S10” means the tensile stress at 10% elongation and may be referred to as the “10% modulus.” Herein, S10 is believed to correlate with sealing performance. Accordingly, according to an embodiment of the invention, S10 should be made as large as possible, while at the same time S100 should not be greater than a predetermined maximum at which the valve can be installed successfully.

The modulus may advantageously be in a predetermined range, which may be dependent on the particulars of the wheel and valve hole dimensions and orientation, the desired maximum g-force, the tire pressure, and the like. For example, S100 may be from 300-700, or 330-640, or 380-550, or 400-500 psi. If the 5100 modulus is too high, the valve will be too hard to install in the valve hole, resulting in tearing and the like. Likewise, S10 may be from 90-160, or 100-155, or 90-130 psi. If the S10 modulus is too low, the g-forces will result in air leaks during use. It should be understood that S10 and S100 are not completely independent, i.e., compounding to increase one generally also increases the other. Still the shape of the stress-strain curve can be optimized to balance the competing goals for S10 and S100.

An alternate modulus indication is rubber hardness measured with a durometer, preferably on the Shore A scale, for example in the range from 65-76, or 65-70, or about 67. However, because of the two competing goals of low installation force and high resistance to leaks, a single modulus indication such as rubber hardness is generally not adequate for designing the rubber composition. Therefore, use of S10 and S100 is preferred.

The embodiments of the invention may be manufactured using various rubber molding methods. The resilient member maybe may be over molded by injection molding, transfer molding, or compression molding onto the brass stem. The stem may be pre-coated with adhesive by spraying, dipping, spray tumbling, or other known coating methods.

The tire valve may possess axisymmetry or be of generally cylindrical, symmetric shape, or the tire valve may have asymmetric features. U.S. Pub. No. 2012/103432A1 describes some asymmetric features which may be advantageously applied to embodiments of the invention, including, for example, a reduction in size of the rib in certain portions of the circumference, an undercut within the rubber on the lower side of the valve body, the aforementioned lip may spread outward around a portion of the circumference of the hole, and the like. Such modifications may be particularly advantageous to reduce the installation forces when S100 is on the high side of a preferred range.

As mentioned in the background section, modern performance demands include higher g-forces and higher temperatures resulting in higher stresses on the resilient member. The mounting of a pressure sensor module or sending unit onto the valve body inside the wheel shifts the center of mass and causes the valve to want to pivot in the valve hole during wheel rotation. This pivoting motion can directly cause air to leak between the rubber and the wheel, or it can cause cracking in the rubber and accelerate crack propagation, which also leads to air leaks. High temperatures can reduce the strength of the rubber, resulting in increased cracking and/or crack propagation. High temperatures also cause compression set and/or heat aging that can, over time, degrade or destroy the resilience required for air-tight valve to rim sealing.

Tire valves have been tested mounted in wheel rims according to a heated, high speed test protocol. For the test, pressurized valves are subjected to one or more cycles in which the wheel speed reaches 1400 G and the ambient temperature reaches 85° C. Herein, “g-force” is the ratio of the centrifugal acceleration at a given rotational speed to the acceleration of gravity, and therefore “G” is dimensionless, simply indicating g-force. This wheel speed corresponds to more than 2000 rpm and may be typical of a full size auto (depending on tire size, of course) traveling more than 270 km/h. Leaking is indicated by a loss of pressure in the valve. After the test, the tire valve is inspected to try to determine the cause of the leak, which may be due to cracks in the rubber, dislocation of the rubber from proper seating in the hole, rotation or other movement of the valve and housing, loss of adhesion between rubber and brass, metal valve body, and the like. Typically three valves are tested so the results can be averaged. The maximum total test time is hoped to reach about 120 hours. The time at which leakage occurs is noted if a valve does not pass the test without leakage.

Several Comparative Examples (“Comp. Ex.”) and inventive Examples (“Ex.”) are compared in Tables 1-3 below to illustrate embodiments of the invention and their advantages over prior art.

Comp. Ex. 1 represents a tire valve having a conventional rubber composition, i.e. the experimental “control” sample. The composition of Comp. Ex. 1 is believed to be a blend of SBR, EPDM, and BR as the elastomer component, filled with carbon black and/or silica for reinforcement and cost reduction, with oil added for adjusting the hardness and further cost reduction, and with typical amounts of other well-known ingredients such anti-oxidants, anti-ozonants, process aids, other fillers, sulfur and cure accelerators. Typical properties for such blends may be found in ASTM D-2000 Table 6 for “BA” rated rubber materials. The rubber used for Comp. Ex. 1 exhibits maximum use temperature somewhere in the range of about 70-100° C., Shore A rubber hardness of about 58, tensile strength of 2170 psi (15 MPa), elongation at break of 516%, S100 of 279 psi (1.9 MPa) , and density of about 1.15 g/cc. Tire valves with this rubber are capable of passing low-medium speed endurance tests that simulate conventional tire applications, but are incapable of passing the heated, high-speed tests necessary for modern applications.

Comp. Ex. 2 is a conventional sulfur-cured (not EV) EPDM formulation for tire valve stems as found in the Vanderbilt Rubber Handbook, p. 163 (1978).

Ex. 3 is an embodiment of the invention based on an oil-extended EPDM polymer, Vistalon 3666, sold under that trade mark by ExxonMobil. The rubber composition includes 75 parts of oil (which came from the EPDM grade), 20 parts of barytes, and an EV cure with 0.65 parts of sulfur and 5.2 parts of accelerators, for a ratio of accelerators to sulfur of 8:1. Ex. 4 and Ex. 5 use non-oil-extended EPDM grades to achieve suitable properties for the inventive tire valves. The Royalene EPDM is sold under that trade mark by Lion Copolymer, and the Nordel EPDM is sold under that trade mark by The Dow Chemical Company.

Some key physical properties are shown in Table 2. Comp. Ex. 1 and 2 are too soft (i.e., too low in modulus) for suitable performance in high-speed spin testing. They also lack sufficient heat resistance. Ex. 3 to 5 have both suitable low-strain modulus (10% modulus) and suitable 100% modulus for insertion into a valve hole in a wheel for a snap-in application. They also exhibit excellent heat resistance.

Some tire-valve spin test results are shown in Table 3 for Comp. Ex. 1. Note that Comp. Ex. 1 could not handle the hot high-speed test, leaking at less than 10% of the targeted 120 hours. The first leak appeared at 1.5 hours, the last leak at 11.5 hours, and the average time to leak was 5.6 hours. Comp. Ex. 2 was not tested. Ex. 3, on the other hand performed very well on the hot, high speed tire valve test, lasting 92.2 hours without a leak on the average. Ex. 4 passed spin testing. Ex. 5 had an adhesion problem, which should be solved by a suitable choice and/or application of adhesive.

TABLE 1

| | Comp. | Comp. | | | |
|---|---|---|---|---|---|
| | Ex. 1 | Ex. 2 | Ex. 3 | Ex. 4 | Ex. 5 |
| Elastomer | SBR | Epsyn | Vistalon | Royalene | Nordel |
| | blend | 70A¹ | 3666² | 512³ | IP4640⁴ |
| Carbon Black | Yes | 60 | 125 | 50 | 60 |
| Silica | Yes | 50 | 0 | 0 | 0 |
| Oil | Yes | 75 | 75 | 20 | 20 |
| High Density Filler | Yes | 0 | 20 BaSO₄ | 20 BaSO₄ | 20 BaSO₄ |
| Sulfur | Yes | 2 | 0.65 | 0.65 | 0.65 |
| Accelerators | Yes | 2.75 | 5.2 | 5.2 | 5.2 |

¹EPDM, 55% ethylene, 2% ENB, 70 MV.
²EPDM, 64% ethylene, 4.5% ENB, 52 MV, 75 PHR oil-extended.
³EPDM, 68% ethylene, 3.9% ENB, 58 MV.
⁴EPDM, 55% ethylene, 5% ENB, 40 MV.

TABLE 2

| | Comp. | Comp. | | | |
|---|---|---|---|---|---|
| | Ex. 1 | Ex. 2 | Ex. 3 | Ex. 4 | Ex. 5 |
| 10% modulus (psi)¹ | — | — | 105 | 99 | 111 |
| 100% modulus (psi) | 279 | — | 531 | 366 | 502 |
| 300% modulus (psi) | — | 1100 | 1834 | 1650 | 1750 |
| Tear Strength (ppi) | | 155 | 228 | 234 | 213 |
| Shore A Hardness | 58 | 64 | 67 | 67 | 67 |
| Heat resistance | Poor¹ | Poor¹ | Ok @ | Ok @ | Ok @ |
| | | | 150° C. | 150° C. | 150° C. |

¹loses about half its elongation in 24 hrs. at 125° C.

TABLE 3

| | Comp. | Comp. | | | |
|---|---|---|---|---|---|
| | Ex. 1 | Ex. 2 | Ex. 3 | Ex. 4 | Ex. 5 |
| Hot, high speed testing¹ | | — | | | |
| First leak (hrs) | 1.5 | | 82.2 | | |
| Last leak (hrs) | 11.5 | | 102 | | |
| Average time to leak (hrs) | 5.6 | | 96.4 | Pass | 1 hr.² |

¹1400 G, 85° C.
²adhesion failure.

Thus, the rubber compositions disclosed herein provide an excellent balance of properties for use in snap-in tire valve applications, including excellent heat resistance, adhesion to brass, retention of air, and physical endurance at high wheel rotational speeds. It is also believed that the compositions and resilient member designs disclosed herein would be useful for other types of valves requiring excellent sealing, heat resistance and physical properties, such as pressure relief valves, fill valves for other gases or liquids, and the like.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A tire valve for mounting in a valve hole in a wheel rim, comprising:
a valve body; and a resilient member surrounding and bonded to at least a portion of said valve body and having an overall shape including a groove and a rib adapted to snap into and be retained in said valve hole;
wherein said resilient member comprises:
a vulcanized rubber composition comprising ethylene alpha-olefin elastomer, carbon black, high-density inert filler, and an efficient vulcanization (“EV”) cure system.

2. The tire valve of claim 1 wherein said elastomer is ethylene propylene diene elastomer (“EPDM”).

3. The tire valve of claim 1 wherein said EV cure system comprises elemental sulfur and cure accelerators at a ratio of cure accelerators to elemental sulfur in the range from about 4:1 up to about 10:1.

4. The tire valve of claim 1 wherein said EV cure system comprises less than 1 part of elemental sulfur by weight per hundred parts EPDM.

5. The tire valve of claim 1 wherein said vulcanized rubber composition exhibits a tensile stress at 10% elongation in the range of greater than 90 psi; and a tensile stress at 100% elongation in the range of less than 550 psi.

6. The tire valve of claim 1 further comprising an adhesive layer between said valve body and said resilient member.

7. The tire valve of claim 1 wherein said high-density inert filler is barium sulfate and is present in the range of 10 to 30 parts weight per hundred parts of elastomer.

8. The tire valve of claim 1 wherein said high-density inert filler is barium sulfate with an average particle size less than 20 μm.

9. The tire valve of claim 1 wherein said EPDM has an ethylene content in the range of 60-70 mole %.

10. The tire valve of claim 1 wherein said EPDM has ENB as the diene and the amount of said diene in the EPDM is in the range 3-5 mole %.

11. A method comprising:
i) applying an adhesive to a brass tire valve stem;
ii) over-molding the adhesive coated brass tire valve stem with a rubber composition comprising ethylene propylene elastomer, carbon black, high-density inert filler, and an EV cure system; and
iii) vulcanizing said over-molded stem with rubber composition to produce a rubber seal shaped to snap into a valve hole in a wheel rim.

12. The method of claim 11 wherein said vulcanized rubber composition exhibits a tensile stress at 10% elongation in the range of greater than 90 psi; and a tensile stress at 100% elongation in the range of less than 550 psi.

13. The method of claim 11 wherein said high-density inert filler is barium sulfate and is present in the range of 10 to 30 parts weight per hundred parts of elastomer.

14. A tire valve for mounting in a valve hole in a wheel rim, comprising:
a valve body; and a resilient member surrounding and bonded to at least a portion of said valve body and having an overall shape including a groove and a rib adapted to snap into and be retained in said valve hole;
wherein said resilient member consists of a vulcanized rubber composition comprising ethylene propylene diene elastomer (“EPDM”), carbon black, high-density inert filler, and an efficient vulcanization (“EV”) cure system;
wherein said EV cure system consists of elemental sulfur and cure accelerators at a ratio of cure accelerators to elemental sulfur in the range from about 4:1 up to about 10:1; and
wherein said EV cure system consists of less than 1 part of elemental sulfur by weight per hundred parts EPDM.

15. The tire valve of claim 14 wherein said EV cure system comprises elemental sulfur and cure accelerators at a ratio of cure accelerators to elemental sulfur in the range from about 6:1 up to about 10:1; and
wherein said EV cure system comprises less than 0.8 parts of elemental sulfur by weight per hundred parts EPDM.

16. The tire valve of claim 15 wherein said vulcanized rubber composition exhibits a tensile stress at 10% elongation in the range of greater than 90 psi; and a tensile stress at 100% elongation in the range of less than 550 psi.

17. The tire valve of claim 16 wherein said EPDM is an oil-extended, high molecular weight grade of EPDM comprising at least 50 parts by weight of oil per hundred parts EPDM.

18. The tire valve of claim 17 wherein said vulcanized rubber composition comprises at least 75 parts by weight of oil per hundred parts EPDM.
